(19) United States
(12) Patent Application Publication
(10) Pub. No.: US 2015/0205463 A1
(43) Pub. Date: Jul. 23, 2015

(54) METHOD FOR STORING FORM DATA

(71) Applicants: Momchil FILEV, Mountain View, CA (US); Martin Freund, Mountain View, CA (US)

(72) Inventors: Momchil FILEV, Mountain View, CA (US); Martin Freund, Mountain View, CA (US)

(73) Assignee: GOOGLE INC., Mountain View, CA (US)

(21) Appl. No.: 13/533,900

(22) Filed: Jun. 26, 2012

(51) Int. Cl. G06F 3/0484; G06F 3/0481; G06F 3/01

(52) U.S. Cl. CPC G06F 3/0484; G06F 3/04817

(57) ABSTRACT

Systems and methods for storing data entered online are provided. In some aspects, a method includes loading a user interface with an application; receiving a first data entry at a first area on the user interface and a second data entry at a second area on the user interface; displaying the user interface with the first data entry in the first area and the second data entry in the second area; associating the first data entry with the first area and the second data entry with the second area; storing the data entries in a remote storage; detecting an interruption in the user interface; retrieving, after detecting the interruption, the stored data entries from the memory; and reproducing the user interface using the retrieved first data entry in the first area and the second data entry in the second area.

### BACKGROUND

The subject technology generally relates to storing form data, e.g., entries on a web page.

Currently, when a user is in the process of entering form data on a user interface (e.g., entering information on a web page) and the entry is interrupted by, e.g., a power outage, or problems of the user's computer or web browser, the user may have to re-enter the same information again.

### SUMMARY

The disclosed subject matter relates to a machine-implemented method for storing data entered online. The method includes loading a user interface with an application; receiving a first data entry at a first area on the user interface and a second data entry at a second area on the user interface; displaying the user interface with the first data entry in the first area and the second data entry in the second area; associating the first data entry with the first area and the second data entry with the second area; storing the first data entry associated with the first area and second data entry associated with the second area in a memory, wherein the memory is a remote storage which has a web-based interface for configuring storage of the first data entry and the second data entry; detecting an interruption in the user interface; retrieving, after detecting the interruption, the stored first data entry in the first area and the second data entry in the second area from the memory; and reproducing the user interface using the retrieved first data entry in the first area and the second data entry in the second area.

The disclosed subject matter relates to a non-transitory computer-readable medium that includes instructions. The instructions include code for loading a user interface with an application; receiving a first data entry at a first area on the user interface and a second data entry at a second area on the user interface; displaying the user interface with the first data entry in the first area and the second data entry in the second area; associating the first data entry with the first area and the second data entry with the second area; storing the first data entry associated with the first area and second data entry associated with the second area in a remote storage which has a web-based interface for configuring storage of the first data entry and the second data entry; detecting an interruption in the user interface; retrieving, after detecting the interruption, the stored first data entry in the first area and the second data entry in the second area; reproducing the user interface using the retrieved first data entry in the first area and the second data entry in the second area; and displaying the reproduced user interface.

The disclosed subject matter relates to a system that includes one or more processors; and a machine-readable medium comprising instructions stored therein. When executed by the processors, the instructions cause the processors to perform operations comprising: loading a user interface with an application; receiving a first data entry at a first area on the user interface and a second data entry at a second area on the user interface; displaying the user interface with the first data entry in the first area and the second data entry in the second area; determining the name of the first area and the name of the second area; associating the first data entry with the first area and the second data entry with the second area; storing the first data entry associated with the first area and second data entry associated with the second area in a remote storage which has a web-based interface for configuring storage of the first data entry and the second data entry; and filling the first data entry to a second user interface when the name of the first area appears on the second user interface.

Various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

FIG. 1 illustrates a block diagram of an example system for storing form data.

FIG. 2 illustrates an example of a user interface of a storage device.

FIG. 3 illustrates a block diagram of an example of the user device shown in FIG. 1.

FIG. 4 illustrates an example of a web page.

FIG. 5 illustrates an example of form data stored in a storage device.

FIG. 6 illustrates an example of a web page filled with data entries from a user.

FIG. 7 illustrates a block diagram of an example of the server shown in FIG. 1.

FIGS. 8A and 8B illustrate a flowchart of an example of a method for storing form data.

FIG. 9 conceptually illustrates an example electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced without these specific details. In some instances, well-known structures and components are shown in block diagram form in order to avoid obscuring the concepts of the subject technology.

The subject technology is directed to techniques for storing form data by an application, e.g., storing data entries on a web page by a web browser. With a user's permission, the application (e.g., a web browser) may export data entries made by the user on a user interface (e.g., a web page loaded by a web browser) and store the data entries in a memory (e.g., a drive separate from the user's computer or a drive on cloud). If the user is filling out a form including at least two fields, the web browser may associate a data entry with its field. When the data entry is interrupted and the web page is to be re-loaded, the web browser may access the memory and automatically fill the stored data entries back to the web page, so that the user may continue the data entry, instead of re-entering the data entered before the interruption.

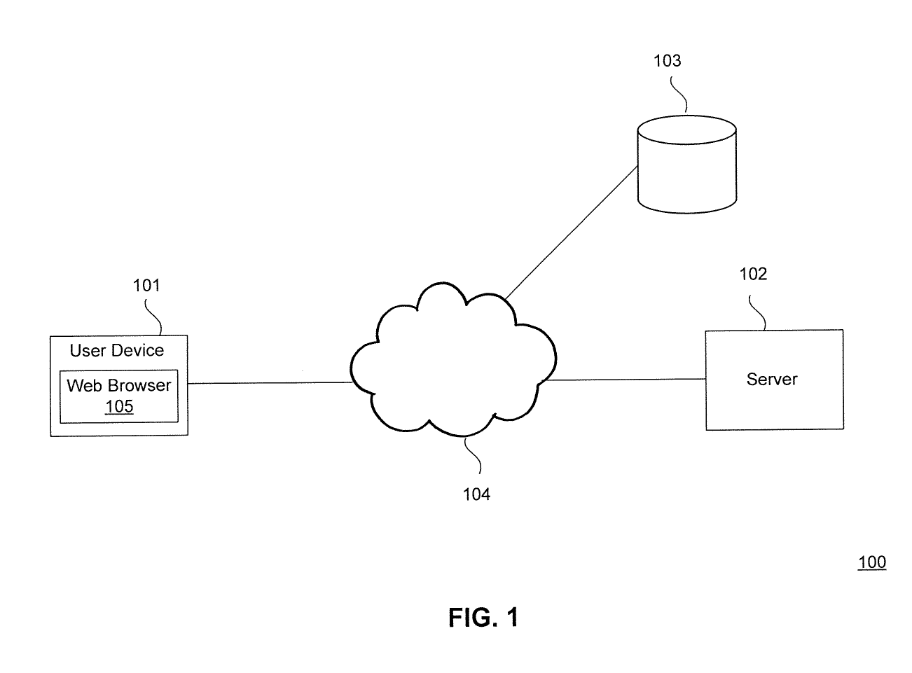

FIG. 1 illustrates a block diagram of an example system 100 for storing form data. An example of the form data may be data entries on a web page. As shown, a user device 101, a server 102 and a storage device 103 may be coupled to each other via a network 104. One user device, one server and one storage device have been illustrated for simplicity. There may be more user devices, servers and/or storage devices. The network 104 may correspond to one or more of, e.g., the Internet, an intranet, a local area network, a cellular network or another communication network.

A user may interact with the network 104 at the user device 101. The user device 101 may include an application for loading a user interface. One example of the application may be a web browser 105 which may enable the user to access, retrieve and view documents and other resources on the Internet. In response to a request from a user, the web browser 105 may open a user interface, e.g., a web page which may include at least one field to be filled. The user may enter data in the field, and the web browser 105 may automatically and periodically send the data entry to the server 102. The server 102 may store the data entry from the web browser 105 in the storage device 103.

The storage device 103 may be any commercially available storage device. In some implementations, the storage device 103 may be separate from the user device 101 or may be a remote storage. In some implementations, the storage device 103 may be a cloud storage device. In some implementations, the storage device 103 is a networked online storage where data is stored in virtualized pools of storage. In some implementations, the storage device 103 may be accessed through a web service application programming interface (API), a gateway, or a web-based user interface. In some implementations, the storage device 103 may be load shared among multiple physical servers which may be at different locations. In some implementations, a user may be allocated a section of the storage device 103. A user's section may include one or more subsections, and one of the subsections may be used for storing form data, e.g., data entries submitted by the user on one or more web pages.

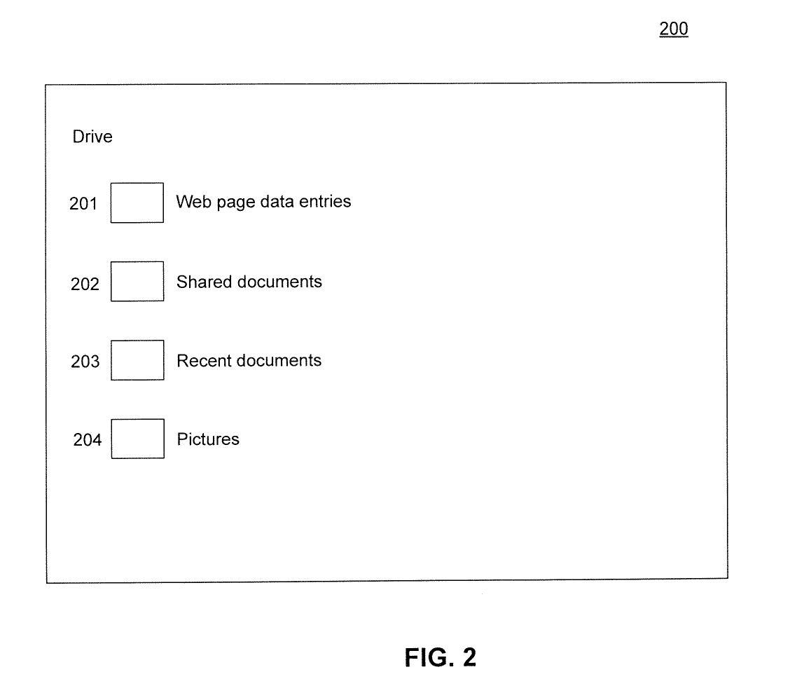

FIG. 2 illustrates an example of a user interface of the storage device 103. As shown, a number of folders may be displayed on a user interface 200, e.g., a folder 201 for form data (e.g., web page data entries), a folder 202 for shared documents, a folder 203 for recent documents and a folder 204 for pictures. In some implementations, the folders may be set up by the user. Each of the folders may correspond to a subsection of the user's section in the storage device 103. In some implementations, the user may be asked whether he/she wants to have a folder for storing data he/she will enter on web pages. Data entries submitted by the user on a web page may be exported by the web browser 105 and stored in the storage device 103 when the user wants to have such a folder.

When the data entry is interrupted and the web page is to be reloaded in response to a request, the web browser 105 may reload the web page, access the data entries stored in the storage device 103, automatically fill the stored data entries back to the web page and enable the web page filled with the stored data entries to be displayed.

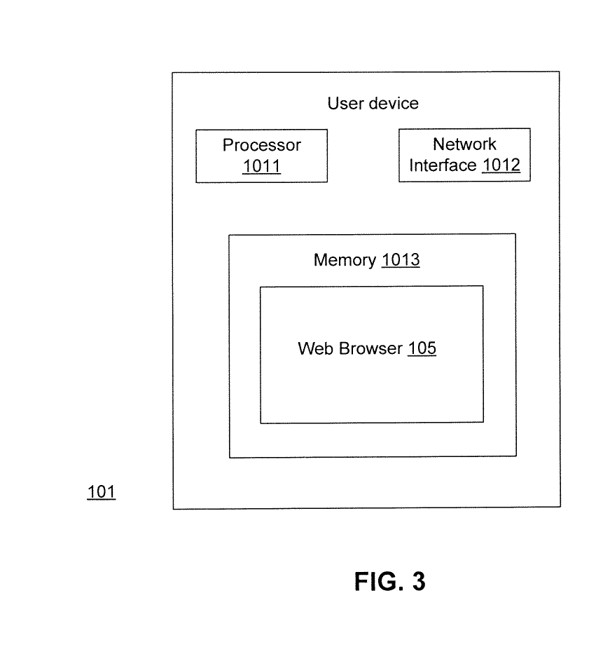

FIG. 3 illustrates a block diagram of an example of the user device 101 shown in FIG. 1. The user device 101 may be any computing device capable of displaying content, for example, via a web browser or via a specialized application. The user device 101 may be, e.g., a laptop computer, a desktop computer, a tablet computer, a mobile phone, a smartphone, a personal digital assistant (PDA), a netbook, a physical machine or a virtual machine. Other devices can also implement the functionalities of the user device 101.

The user device 101 may include a processor 1011, a network interface 1012 and a memory 1013. The processor 1011 is configured to execute computer instructions that are stored in a computer-readable medium, for example, the memory 1013. The processor 1011 may be a central processing unit (CPU). The network interface 1012 is configured to allow the user device 101 to transmit and receive data in the network 104. The network interface 1012 may include one or more network interface cards (NICs). The memory 1013 stores data and instructions.

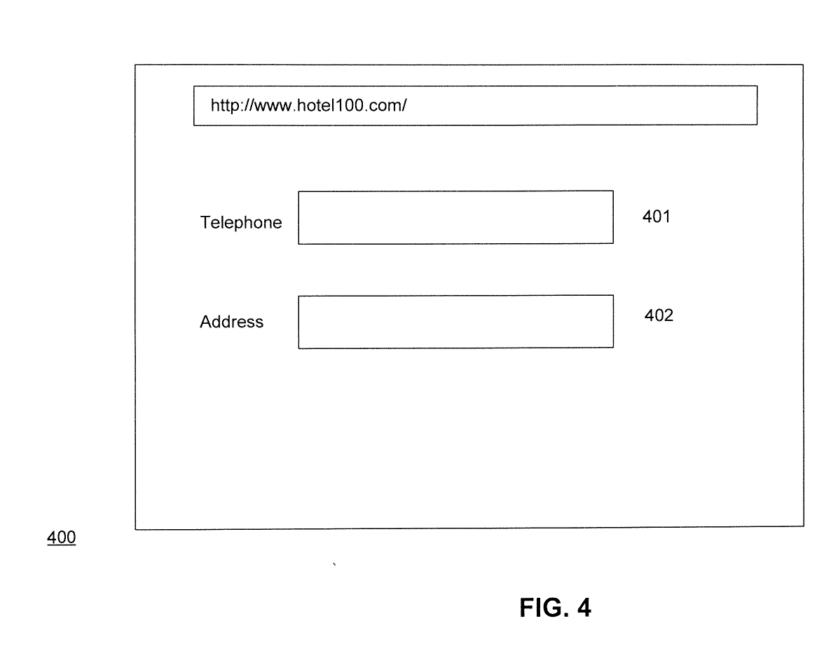

As illustrated, the memory 1013 may store the web browser 105. The web browser 105 may load a web page in response to a user request. FIG. 4 illustrates an example of a web page 400 which may be loaded in response to an input “http://www.hotel100.com” in the address bar of the web browser 105. A user may be in the process of making a hotel reservation, and the web page 400 may be one of a number of web pages that request information from the user for making the hotel reservation. As shown, the web page 400 may have a first field 401 named “Telephone” which requests the user to fill in his/her telephone number, and a second field 402 named “Address” which requests the user to fill in his/her address. The HTML for the fields may be as follows:

<form>
Telephone: <input type=”text” name=”telephone”/><br />
Address: <input type=”text” name=”address”/>
<form>

The user may enter his/her telephone number in the field 401 and his/her address in the field 402.

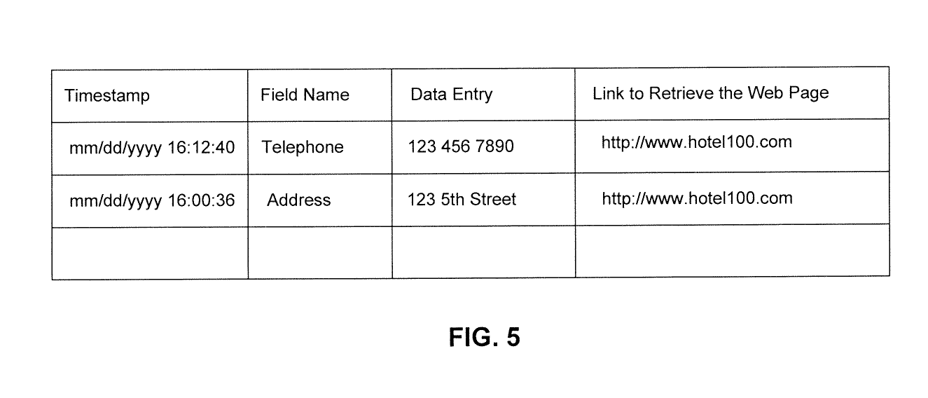

The web browser 105 may receive the data entries from the user, determine the web page on which the data entries are received (e.g., http://www.hotel100.com), and determine the field names of the data entries (e.g., telephone and address). The web browser 105 may then associate the entries with the web page and their respective fields on the web page, and store the web page, the field names and the data entries in the storage device 103. FIG. 5 illustrates an example of web page data entries stored in the storage device 103. As shown, each entry may be associated with a timestamp 501, a field name 502 (e.g., Telephone, and Address), and a link to the web page 503 (e.g., http://www.hotel100.com) on which the data entries are received.

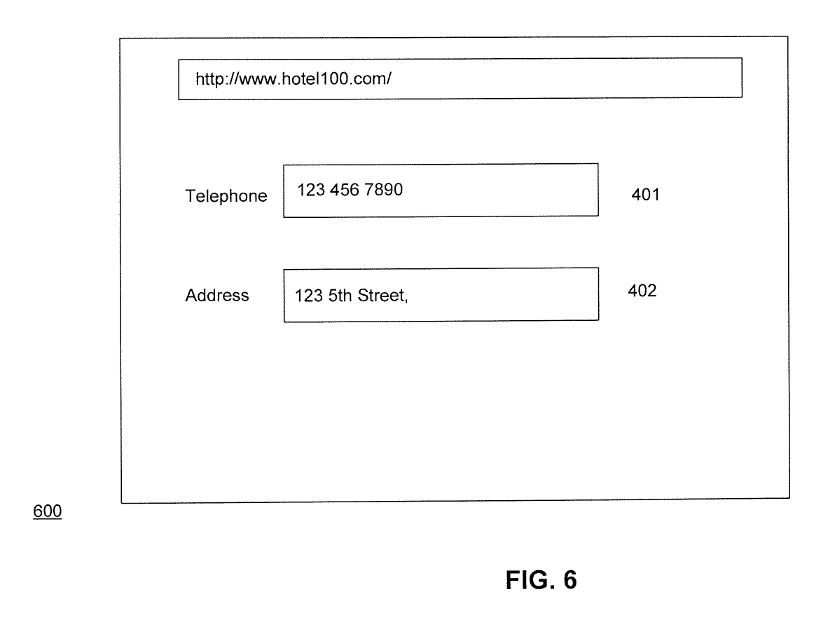

The web browser 105 may also enable a web page filled with data entries from the user to be displayed on the user device 101. FIG. 6 illustrates an example of a web page filled with data entries from the user. As shown, the field 401 is filled with the user's telephone number (e.g., 123 456 7890), and the field 402 is filled with part of the user's address received before the data entry is interrupted (e.g., 123 5th Street).

The data entry may be interrupted by, e.g., a power outage, or problems of the computer or the web browser. The data entry may also be interrupted by the user's action, e.g., putting the user device 101 to sleep, moving the user device 101 to a new location without Wi-Fi, or accidentally closing the web page. The web browser 105 may detect such an interruption. When the web browser 105 receives a request to reload the web page 400 after an interruption, it may reload the web page 400, access the storage device 103 for stored data entries associated with the web page 400, automatically fill the stored data entries back to their respective fields on the web page 400, and enable display of the web page 600 which is automatically filled with data entries.

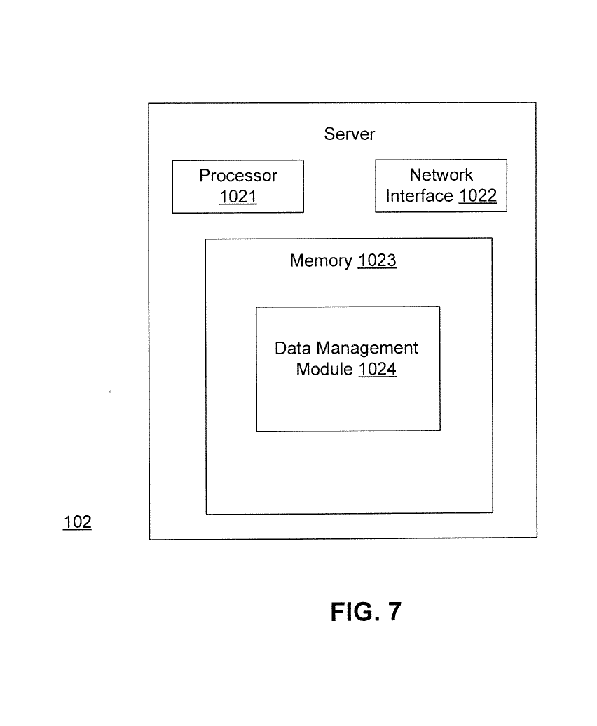

FIG. 7 illustrates a block diagram of an example of the server 102 shown in FIG. 1. The server 102 may be coupled to the user device 101 via the network 104, and may include a processor 1021, a network interface 1022, and a memory 1023. The processor 1021 is configured to execute computer instructions that are stored in a computer-readable medium, for example, the memory 1023. The processor 1021 may be a central processing unit (CPU). The network interface 1022 is configured to allow the server 102 to transmit and receive data in the network 104. The network interface 1022 may include one or more network interface cards (NICs).

The memory 1023 stores data and instructions. As illustrated, the memory 1023 may store a data management module 1024 which may receive data entries from the web browser 105 and store them in the storage device 103. In some implementations, the data management module 1024 may store the data entries from the web browser 105 in a folder set up by the user. In some implementations, the data management module 1024 may store the data entries from the web browser 105 according to the format shown in FIG. 5.

In some implementations, the web browser 105 may store the data entries according to user settings on the format for the data to be stored, in addition to the destination. The format for the data may be, e.g., a text file or screenshot. In some implementations, the web browser 105 may enable the stored data entries to be deleted according to user settings, e.g., when an on-line application is submitted, when the user hits a “Finish” button, or after 3 months. The user settings may be received via a web-based user interface, e.g., the user interface 200 of the storage device 103 shown in FIG. 2.

In some implementations, the web browser 105 may recognize the name of a field (e.g., address, and phone number), associate a data entry with the field, and automatically fill in the field with its associated data entry when the field appears on a different web page.

In some implementations, the web browser 105 may determine whether a field is related to sensitive information (e.g., a social security number, a password and a credit card number), associate a data entry with the field, encrypt the data entry and store the encrypted data entry.

In some implementations, the web browser 105 may store the data entries on a web page in response to a user input, e.g., “Ctrl+s”.

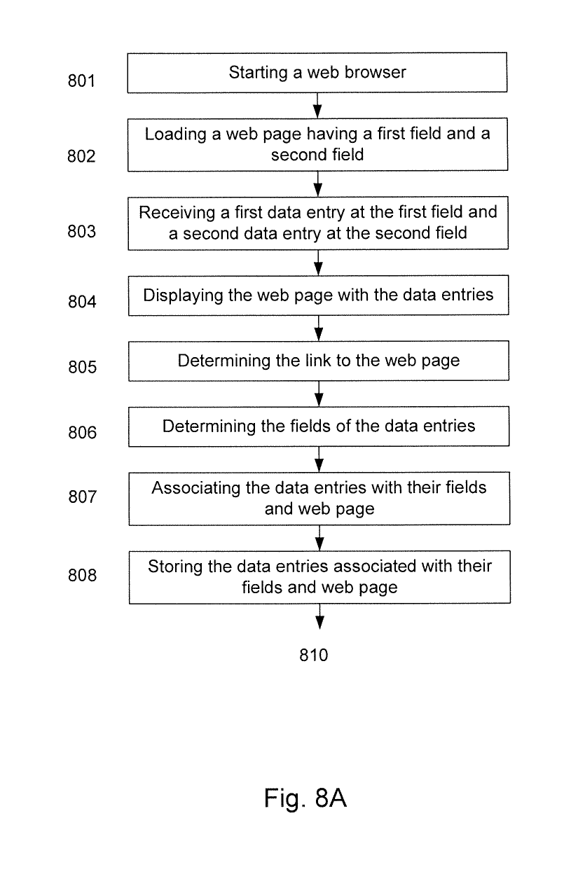

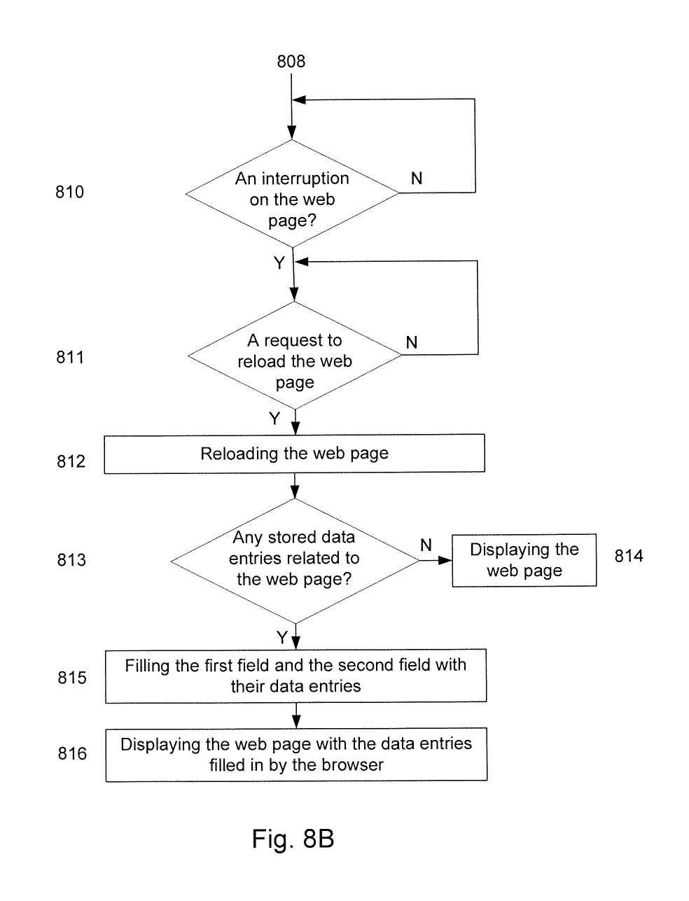

FIGS. 8A and 8B illustrate a flowchart of an example of a method for storing form data.

At 801, an application (e.g., the web browser 105) may be started.

At 802, a user interface for receiving form data may be loaded (e.g., a web page may be loaded by the web browser 105) in response to a user input. An example of the web page may be, e.g., the web page 400 shown in FIG. 4, and an example of the user input may be, e.g., an input “http://www.hotel100.com” in the address bar of the web browser 105. As shown in FIG. 4, the web page 400 may be used for hotel reservation and has the field 401 for the user's telephone number and the field 402 for the user's address.

At 803, form data may be received on the user interface (e.g., the user's telephone number and address may be received on the web page 400), and more specifically, at the fields 401 and 402 respectively.

At 804, the user interface filled with the form data (e.g., the web page 600 filled with the user's data entries) may be displayed.

At 805, the link to the web page on which the data entries are received may be determined (e.g., by the web browser 105). The link to the web page 400 may be, e.g., http://www.hotel100.com.

At 806, the fields at which the data entries are received may be determined (e.g., by the web browser 105). The fields may be, e.g., the field 401 for the user's telephone number and the field 402 for the user's address.

At 807, the user's data entries may be associated with the web page and their respective fields (e.g., by the web browser 105). For example, the web browser 105 may associate the user's phone number 123 456 7890 with the field 401, and the user's address with the field 402. The web browser may also associate the data entries with the link to the web page 400, e.g., http://www.hotel100.com.

At 808, the data entries associated with their respective fields and the link to the web page may be stored (e.g., by the web browser 105 in the storage device 103). In some implementations, the data entries may be stored in the format shown in FIG. 5. In some implementations, the data entries may be stored periodically and automatically. In one example, the data entries may be stored automatically every 5 seconds.

The data entry may be interrupted by, e.g., a power outage, a user's action, or problems of the computer or the browser. At 810, an interruption in the web page 400 may be detected (e.g., by the web browser 105).

At 811, a request to reload the web page 400 may be received (e.g., by the web browser 105). The request may be, e.g., an input “http://www.hotel100.com” in the address bar of the web browser 105.

At 812, the web page 400 may be reloaded in response to the request (e.g., by the web browser 105).

At 813, it may be determined whether there is any stored user data entry on the web page 400. For example, the web browser 105 may search the user's section in the storage device 103 to find out whether there is any data entry associated with the link http://www.hotel100.com.

If not, the web page 400 may be displayed at 814.

If there are stored user data entries associated with the web page 400, at 815, the user data entries may be retrieved, and the user data entries may be automatically filled back to their respective fields. For example, the user's phone number 123 456 7890 may be automatically filled back to the field 401 on the web page 400, and the user's address may be automatically filled back to the field 402 on the web page 400.

At 816, the web page filled with user data entries (e.g., the web page 600) may be displayed, and the user may continue the data entry.

Although FIG. 8 is described with reference to the configurations of FIG. 1, the process of FIG. 8 is not limited to such configurations and can be applied to other systems and configurations.

FIGS. 2-8 illustrate examples related to web pages and web browsers, but the subject technology can apply to other types of applications as well (e.g., smartphone applications).

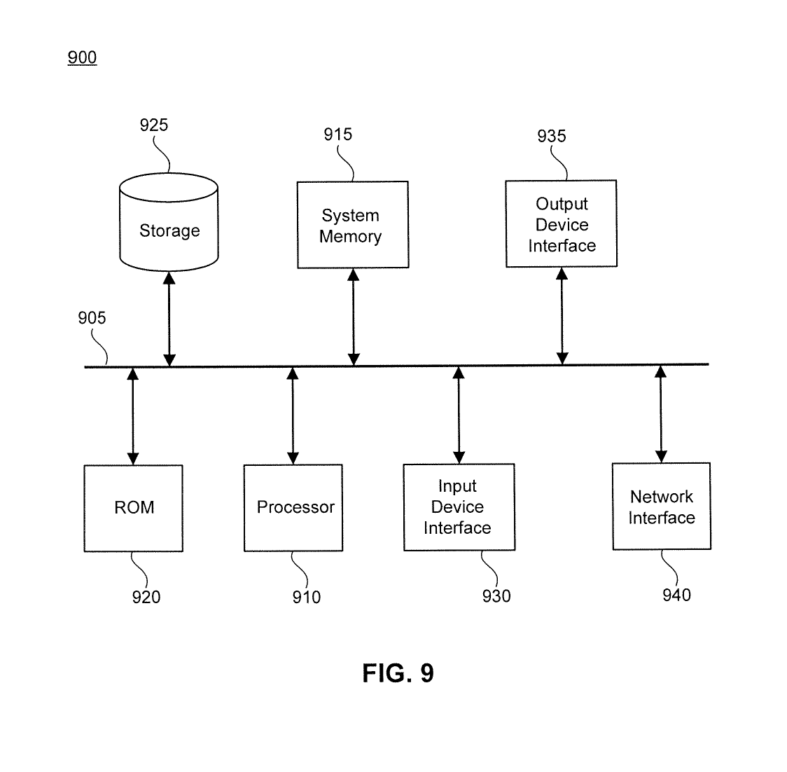

FIG. 9 conceptually illustrates an electronic system 900 with which some implementations of the subject technology are implemented. For example, one or more of the user device 101 and the server 102 may be implemented using the arrangement of the electronic system 900. The electronic system 900 can be a computer (e.g., a mobile phone, PDA), or any other sort of electronic device. Such an electronic system includes various types of computer readable media and interfaces for various other types of computer readable media. Electronic system 900 includes a bus 905, processing unit(s) 910, a system memory 915, a read-only memory 920, a permanent storage device 925, an input device interface 930, an output device interface 935, and a network interface 940.

The bus 905 collectively represents all system, peripheral, and chipset buses that communicatively connect the numerous internal devices of the electronic system 900. For instance, the bus 905 communicatively connects the processing unit(s) 910 with the read-only memory 920, the system memory 915, and the permanent storage device 925.

From these various memory units, the processing unit(s) 910 retrieves instructions to execute and data to process in order to execute the processes of the subject technology. The processing unit(s) can be a single processor or a multi-core processor in different implementations.

The read-only-memory (ROM) 920 stores static data and instructions that are needed by the processing unit(s) 910 and other modules of the electronic system. The permanent storage device 925, on the other hand, is a read-and-write memory device. This device is a non-volatile memory unit that stores instructions and data even when the electronic system 900 is off. Some implementations of the subject technology use a mass-storage device (for example a magnetic or optical disk and its corresponding disk drive) as the permanent storage device 925.

Other implementations use a removable storage device (for example a floppy disk, flash drive, and its corresponding disk drive) as the permanent storage device 925. Like the permanent storage device 925, the system memory 915 is a read-and-write memory device. However, unlike storage device 925, the system memory 915 is a volatile read-and-write memory, such a random access memory. The system memory 915 stores some of the instructions and data that the processor needs at runtime. In some implementations, the processes of the subject technology are stored in the system memory 915, the permanent storage device 925, or the read-only memory 920. For example, the various memory units include instructions for storing form data (e.g., user entries on web pages) in accordance with some implementations. From these various memory units, the processing unit(s) 910 retrieves instructions to execute and data to process in order to execute the processes of some implementations.

The bus 905 also connects to the input and output device interfaces 930 and 935. The input device interface 930 enables the user to communicate information and select commands to the electronic system. Input devices used with input device interface 930 include, for example, alphanumeric keyboards and pointing devices (also called “cursor control devices”). Output device interfaces 935 enables, for example, the display of images generated by the electronic system 900. Output devices used with output device interface 935 include, for example, printers and display devices, for example cathode ray tubes (CRT) or liquid crystal displays (LCD). Some implementations include devices for example a touchscreen that functions as both input and output devices.

Finally, as shown in FIG. 9, bus 905 also couples electronic system 900 to a network (not shown) through a network interface 940. In this manner, the electronic system 900 can be a part of a network of computers (for example a local area network (“LAN”), a wide area network (“WAN”), or an Intranet, or a network of networks, for example the Internet. Any or all components of electronic system 900 can be used in conjunction with the subject technology.

The above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some aspects of the disclosed subject matter, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase for example an “aspect” does not imply that the aspect is essential to the subject technology or that the aspect applies to all configurations of the subject technology. A disclosure relating to an aspect may apply to all configurations, or one or more configurations. A phrase for example an aspect may refer to one or more aspects and vice versa. A phrase for example a “configuration” does not imply that such configuration is essential to the subject technology or that such configuration applies to all configurations of the subject technology. A disclosure relating to a configuration may apply to all configurations, or one or more configurations. A phrase for example a configuration may refer to one or more configurations and vice versa.

1. A computer-implemented method for storing data entered online, the method comprising:
loading a user interface with an application;
receiving a first data entry at a first area on the user interface and a second data entry at a second area on the user interface;
displaying the user interface with the first data entry in the first area and the second data entry in the second area;
associating the first data entry with the first area and the second data entry with the second area;
storing the first data entry associated with the first area and second data entry associated with the second area in a memory, wherein the memory is a remote storage having a web-based interface for configuring storage of the first data entry and the second data entry;
detecting an interruption in the user interface;
detecting a request for reloading the user interface;
determining whether there is a data entry associated with the user interface in the memory;
displaying the user interface if there is no data entry associated with the user interface in the memory;
retrieving, after detecting the interruption, the stored first data entry in the first area and the second data entry in the second area from the memory; and
reproducing the user interface using the retrieved first data entry in the first area and the second data entry in the second area.

2. The method of claim 1, further comprising: displaying the reproduced user interface.

3. The method of claim 1, further comprising: determining a link to the user interface before associating the first data entry with the first area and the second data entry with the second area.

4. The method of claim 1, further comprising: determining the name of the first area and the name of the second area before associating the first data entry with the first area and the second data entry with the second area.

5. The method of claim 4, further comprising: filling the first data entry to a second user interface when the name of the first area appears on the second user interface.

6. (canceled)

7. The method of claim 1, further comprising: reloading the user interface in response to the request for reloading the user interface.

8. (canceled)

9. (canceled)

10. The method of claim 1, wherein the first data entry and the second data entry are stored according to user settings on a destination for the data entries.

11. The method of claim 1, further comprising: deleting the stored first data entry and second data entry according to user settings.

12. The method of claim 1, further comprising: determining whether the first area is related to sensitive information.

13. The method of claim 12, further comprising: encrypting the first data entry when the first area is related to sensitive information.

14. The method of claim 1, wherein the first data entry and the second data entry are stored automatically.

15. The method of claim 1, wherein the first data entry and the second data entry are stored periodically.

16. The method of claim 1, wherein the first data entry and the second data entry are stored in response to a user input.

17. The method of claim 1, wherein the application corresponds to a web browser.

18. The method of claim 17, wherein the user interface corresponds to a web page.

19. A non-transitory computer-readable medium for storing data entered online, the computer-readable medium comprising instructions that, when executed by a computer, cause the computer to:
load a user interface with an application;
receive a first data entry at a first area on the user interface and a second data entry at a second area on the user interface;
display the user interface with the first data entry in the first area and the second data entry in the second area;
associate the first data entry with the first area and the second data entry with the second area;
store the first data entry associated with the first area and second data entry associated with the second area in a remote storage which has a web-based interface for configuring storage of the first data entry and the second data entry;
detect an interruption in the user interface;
detect a request for reloading the user interface;
determine whether there is a data entry associated with the user interface in the memory;
display the user interface if there is no data entry associated with the user interface in the memory;
retrieve, after detecting the interruption, the stored first data entry in the first area and the second data entry in the second area;
reproduce the user interface using the retrieved first data entry in the first area and the second data entry in the second area; and
display the reproduced user interface.

20. A system comprising:
one or more processors; and
a machine-readable medium comprising instructions stored therein, which when executed by the processors, cause the processors to perform operations comprising:
loading a user interface with an application;
receiving a first data entry at a first area on the user interface and a second data entry at a second area on the user interface;
displaying the user interface with the first data entry in the first area and the second data entry in the second area;
determining the name of the first area and the name of the second area;
associating the first data entry with the first area and the second data entry with the second area;
storing the first data entry associated with the first area and second data entry associated with the second area in a remote storage which has a web-based interface for configuring storage of the first data entry and the second data entry;
detecting a request for reloading the user interface;
determining whether there is a data entry associated with the user interface in the memory;
displaying the user interface if there is no data entry associated with the user interface in the memory; and
filling the first data entry to a second user interface when the name of the first area appears on the second user interface.

21. The method of claim 1, wherein each of the first and second data entries are associated with a timestamp, a field name and a link to a web page.
